(19) United States
(12) Patent Application Publication
(10) Pub. No.: US 2009/0303449 A1
(43) Pub. Date: Dec. 10, 2009

(54) PROJECTOR AND METHOD FOR OPERATING A PROJECTOR

(75) Inventors: Francesca Schuler, Des Plaines, IL (US); Krishna Jonnalagadda, Algonquin, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/132,662

(22) Filed: Jun. 4, 2008

(51) Int. Cl. G03B 21/14

(52) U.S. Cl. 353/121; 353/122

(57) ABSTRACT

A projection device (100), and method for operating the projection device is provided herein. During operation a projection device will determine a current context, and then associate the context and the display parameters. The association is stored so that the projection device will operate using the display parameters the next time the context is realized.

### FIELD OF THE INVENTION

The present invention relates generally to projectors and in particular, to a method of operating a projector.

### BACKGROUND OF THE INVENTION

As the size of projectors becomes smaller and smaller, their use grows. For example, there are now plans to place small projectors within cellular telephones. As projectors become more and more ubiquitous, the environments in which they are used become more and more varied. This leads to users having to adjust projector settings (e.g., focus, brightness, orientation, . . . , etc.) more and more to accommodate the various settings. It would be beneficial for a projector to autonomously and intelligently handle and manage its settings in an efficient manner to minimize user interaction. Such minimization would enhance consumer mobile device sharing & user experience. Therefore a need exists for a method and apparatus for a projector and method for operating a projector that autonomously and intelligently handles its settings to minimize user interaction. The integration of telephony with projection where there is a local and a remote display (projection) also brings about the need for managing telephony and network events while in projection mode.

### BRIEF DESCRIPTION OF THE DRAWINGS

FIG. 1 is a block diagram of a projector.

FIG. 2 is a flow chart showing the operation of the projector of FIG. 1.

FIG. 3 is a flow chart showing the operation of the projector of FIG. 1.

FIG. 4 is a flow chart showing the operation of the projector of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a projection device, and method for operating the projection device is provided herein. During operation a projection device will determine a current context, and then associate the context and the display parameters. The association is stored so that the projection device will operate using the display parameters the next time the context is realized.

In various embodiments of the present invention, the context utilized for association may comprise elements such as a user's location, file metadata (e.g., a type of file displayed, duration), or devices in proximity. Additionally, display parameters may comprise parameters such as brightness, orientation, resolution, color, a starting point of a presentation, or application metadata.

Because users of the above-described projection device will have the projection device autonomously and intelligently manage its display settings in an efficient manner, user interaction is minimized, enhancing the user's experience.

The present invention encompasses a method for operating a projection device. The method comprises the steps of determining, by the projection device, a location for the projection device, adjusting, by the projection device, display parameters based on the device's location, and projecting an image using the display parameters.

The present invention additionally encompasses a method comprising the steps of determining by a projection device, a context for the projection device, determining by the projection device, display parameters for the projecting device, associating by the projection device, the context and the display parameters, and storing by the projection device, the association so that the projection device will operate using the display parameters when the context is realized.

The present invention additionally encompasses a method for operating a projection device. The method comprises the steps of determining by the projection device, devices in proximity to the projection device, adjusting by the projection device, display parameters based on the devices in proximity, and displaying by the projection device, a first image using the display parameters.

Finally, the present invention encompasses a projection device comprising context-aware circuitry determining a location for the projection device, logic circuitry, adjusting display parameters based on the device's location, and projection circuitry projecting an image using the display parameters.

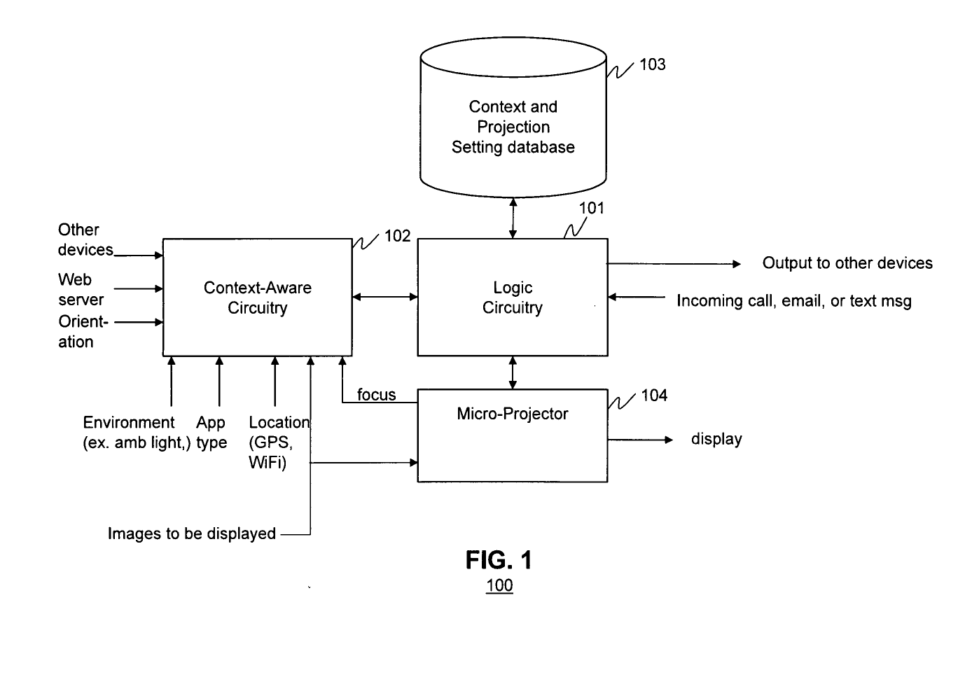

Turning now to the drawings, where like numerals designate like components, FIG. 1 is a block diagram showing projection device 100. As shown, projection device 100 comprises logic circuitry 101, context-aware circuitry 102, context-and-projection-settings database 103, and micro-projector 104. Logic circuitry 101 comprises a digital signal processor (DSP), general purpose microprocessor, a programmable logic device, or application specific integrated circuit (ASIC) and is utilized to accesses and control circuitry 102, 103, and micro-projector 104.

Context-aware circuitry 102 may comprise any device capable of generating a current context. For example, context-aware circuitry 102 may comprise a GPS receiver capable of determining a location of the user device. Alternatively, circuitry 102 may comprise such things as a clock, electronic calendar, ambient light sensor, current focus for micro-projector 104, metadata detector, network detector, orientation sensor, short-range communication circuitry (e.g., Bluetooth™ circuitry) to determine what other electronic devices are near, . . . , etc.

Database 103 comprises standard random access memory and is used to store associations between the current context and the projection settings. Such associations include:
an association between the content to display and what devices are present;
an association between an amount of ambient light and the micro-projector intensity or brightness;
an association between a current location and/or vicinity to a surface and a focus;
an association between a current location, a vicinity to a surface, a projection surface size and a focus;
an association between a file metadata (e.g. black & white file versus color or video vs. image) and adjustment of settings for content;
an association between projection surface color and R,G,B settings to compensate for the surface color;
an association between a location and file metadata (file name, what part of the file was last projected) and other devices in the vicinity;

Finally, micro-projector 104 comprises an apparatus for throwing an image on a screen. An example of such a micro-projector includes the pico projector manufactured by Microvision, Inc. In projecting an image, various settings may be modified to affect the image projected. These settings include, but are not limited to, what image is being projected (e.g., what slide number from a presentation), brightness, orientation, resolution, color, a starting point of a presentation, or presentation metadata.

As discussed above, it would be beneficial for projector 100 to autonomously and intelligently handle and manage its settings in an efficient manner to minimize user interaction and optimize viewing and sharing experiences. In order to address this need, projection device 100 will determine a current context, and then associate the context and the display parameters. The association is stored so that the projection device will operate using the display parameters the next time the context is realized. The above operation will become more clear with the following examples:

### Projection Settings Based on Location

In this particular example, context-aware circuitry 102 comprises circuitry designed to locate the projection device. Such circuitry may, for example, comprise GPS circuitry, a network detection circuitry or a triangulation scheme based on received signal strength from multiple access points to determine what network projector 100 has accessed. Regardless of the means for determining its location, logic circuitry 101 will store (in database 103) associations between the projector's location and the display settings for micro-projector 104. In this example, display settings include metadata to highlight the last slide viewed in a particular presentation. The association between location and presentation metadata (last slide viewed) is stored in database 103. When the presentation is again viewed at that particular location, logic circuitry 101 will access the stored information from database 103 and resume the presentation where it left off.

In another example where context-aware circuitry 102 comprises location circuitry, a focus for micro-projector 104 is associated with a location. In this scenario, logic circuitry 101 will associate location with the focus, and store this information in database 103. When logic circuitry 101 determines that it is again projecting an image at the location, the focus is adjusted automatically.

In a third example, context-aware circuitry 102 comprises circuitry to determine location and an associated projection surface color (e.g wall color) along with the application type being projected and metadata from a file to determine projection settings for the micro-projector. In this example, circuitry may 102 detect that the file being projected is black and white and is being projected against a wall of a certain color (as stored at this location) in a power point presentation. The projector adjusts the R,G,B settings to account for simpler images and compensate for the wall color at this specific location.

### Projection Settings Based on Devices Present

In this particular example, context-aware circuitry 102 comprises circuitry to determine what other devices are present. In this embodiment, circuitry 102 comprises Bluetooth circuitry. Particular devices present are a proxy for the people viewing the projected content. Regardless of the means for determining devices present, logic circuitry 101 will store (in database 103) associations between the devices present and the display settings for micro-projector 104. In this example, display settings include metadata to highlight the last slide viewed in a particular presentation. The association between devices present and presentation metadata (last slide viewed) is stored in database 103. When the presentation is again viewed with a subset of the devices present, logic circuitry 101 will access the stored information from database 103 and resume the presentation where it left off.

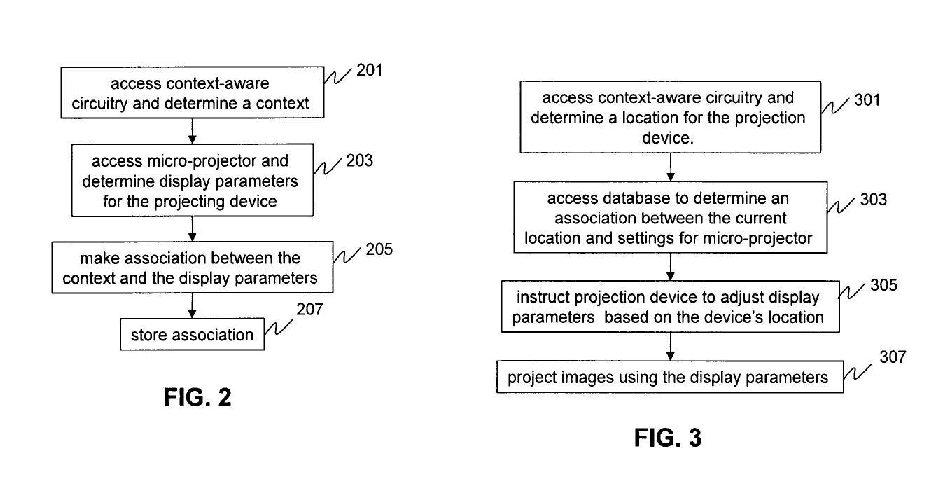

FIG. 2 is a flow chart showing the operation of the projector of FIG. 1. In particular, the logic flow of FIG. 2 shows those steps necessary to train a projector to associate a projector's location with display parameters. The logic flow begins at step 201 where logic circuitry 101 accesses context-aware circuitry 102 and determines a context (e.g., location, an identification of users in a vicinity, metadata from a file being projected, etc.) for the projection device. At step 203, logic circuitry accesses micro-projector 104 and determines display parameters for the projecting device. An association is then made between the context and the display parameters (step 205) and that association is stored in database 103 (step 207) so that the projection device will operate using the display parameters when the context is realized.

FIG. 3 is a flow chart showing operation of the projection device of FIG. 1. In particular, the logic flow of FIG. 3 shows the steps taken by device 100 when properly trained to associate a location with projection settings. The logic flow begins at step 301 where logic circuitry 101 accesses context-aware circuitry 102 and determines a location for the projection device. As discussed, context-aware circuitry may comprise GPS circuitry, or may use a triangulation scheme based on the location of multiple access points in order to determine location. In another embodiment, circuitry 102 may simply infer location by determining what access points are within range.

Logic circuitry 101 then accesses database 103 to determine an association between the current location and settings for micro-projector 104 (step 303). Logic circuitry 101 then instructs projection device 104 to adjust display parameters (e.g., brightness, orientation, resolution, color, a starting point of a presentation, or application metadata) based on the device's location (step 305) and project images using the display parameters (step 307).

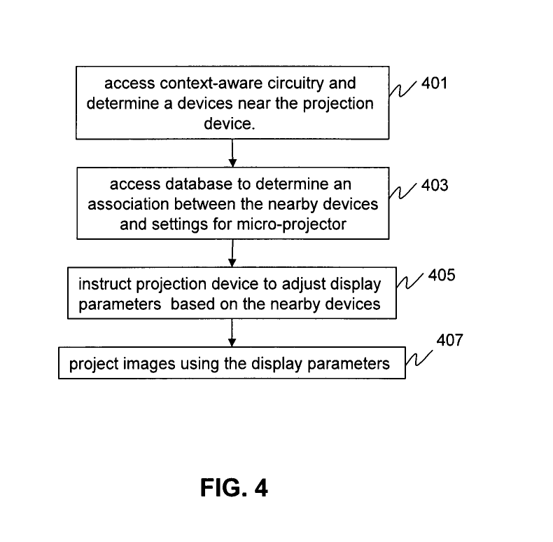

FIG. 4 is a flow chart showing operation of the projection device of FIG. 1. In particular, the logic flow of FIG. 4 shows the steps taken by device 100 when properly trained to associate devices near projection device 100 (e.g., within 30 feet) with projection settings. The logic flow begins at step 401 where logic circuitry 101 accesses context-aware circuitry 102 (Bluetooth circuitry) and determines devices near projection device 100. Logic circuitry 101 then accesses database 103 to determine an association between the nearby devices and settings for micro-projector 104 (step 403). Logic circuitry 101 then instructs projection device 104 to adjust display parameters (e.g., brightness, orientation, resolution, color, a starting point of a presentation, or application metadata) based on the devices present (step 405) and project images using the display parameters (step 407).

It should be noted that the devices in proximity to device 100 may comprise such things as a watch, headset, a phone, . . . etc. These devices may be configured to receive data from device 100. If this is the case, then device 100 may send data via a transmitter (not shown) or Bluetooth circuitry to a device in proximity to the projection device. For example, when the data comprises a caller identification data, connectivity or signal strength indicator, battery indicator, or a phone call, the data may be output from logic circuitry 101 to other devices. Thus, device 100 (logic circuitry 101) may receive an incoming call, email, text message, . . . , etc. and send this information on to other devices present. In a further embodiment of the present invention, logic circuitry 101 may instruct micro-projector 104 to display an indication that data was received.

While the invention has been particularly shown and described with reference to a particular embodiment, it will be understood by those skilled in the art that various changes in form and details may be made therein without departing from the spirit and scope of the invention. It is intended that such changes come within the scope of the following claims:

1. A method for operating a projection device, the method comprising the steps of:
determining, by the projection device, a location for the projection device;
adjusting, by the projection device, display parameters based on the device's location; and
projecting an image using the display parameters.

2. The method of claim 1 wherein the display parameters comprise brightness, orientation, resolution, color, a starting point of a presentation, or application metadata.

3. The method of claim 1 wherein the step of determining the location comprises the step of determining nearby access points.

4. The method in claim 1 where the step of determining the location comprises the step of using a triangulation scheme based on the location of multiple access points.

5. A method comprising the steps of:
determining by a projection device, a context for the projection device;
determining by the projection device, display parameters for the projecting device;
associating by the projection device, the context and the display parameters; and
storing by the projection device, the association so that the projection device will operate using the display parameters when the context is realized.

6. The method of claim 5 wherein the context comprises a location.

7. The method of claim 5 wherein the context comprises an identification of users in a vicinity.

8. The method of claim 7 wherein the context additionally comprises metadata from a file being projected.

9. A method for operating a projection device, the method comprising the steps of:
determining by the projection device, devices in proximity to the projection device;
adjusting by the projection device, display parameters based on the devices in proximity; and
displaying by the projection device, a first image using the display parameters.

10. The method of claim 9 further comprising the step of sending data to a device in proximity to the projection device.

11. The method of claim 10 wherein the data comprises caller identification data, a connectivity or signal strength indicator, battery indicator.

12. The method of claim 10 wherein the data comprises a phone call.

13. The method of claim 9 wherein the device in proximity to the projection device comprises a watch, headset, or a phone.

14. The method of claim 9 further comprising the steps of:
receiving message;
displaying by the projection device, a second image using the display parameters, wherein the second image is displayed in response to the received message and indicates the message was received.

15. A projection device comprising:
context-aware circuitry determining a location for the projection device;
logic circuitry, adjusting display parameters based on the device's location; and
projection circuitry projecting an image using the display parameters.

16. The projection device of claim 15 wherein the display parameters comprise brightness, orientation, resolution, color, a starting point of a presentation, or application metadata.

17. The projection device of claim 15 wherein the context-aware circuitry determines the location by determining a nearby access point.
